(19) United States
(12) Patent Application Publication
(10) Pub. No.: US 2020/0341537 A1
(43) Pub. Date: Oct. 29, 2020

(54) RETENTION FLIP-FLOPS

(71) Applicant: QUALCOMM Incorporated, San Diego, CA (US)

(72) Inventors: Giby SAMSON, San Diego, CA (US); Ramaprasath VILANGUDIPITCHAI, San Diego, CA (US); Seung Hyuk KANG, San Diego, CA (US); Eunjoo HWANG, Sunnyvale, CA (US); Hai ZHU, San Jose, CA (US); Divjyot BHAN, Encinitas, CA (US)

(21) Appl. No.: 16/395,705

(22) Filed: Apr. 26, 2019

(51) Int. Cl. G06F 1/3296; G06F 1/28

(52) U.S. Cl. CPC G06F 1/3296; G06F 1/28

(57) ABSTRACT

In certain aspects, a system comprises a power collapsible logic block, a plurality of retention flip-flops coupled to the power collapsible logic blocks, wherein the plurality of retention flip-flops includes a group of master-slave flip-flops and a group of balloon flip-flops, and a power controller configured to retain states of the group of balloon flip-flops and states of the group of master-slave flip-flops in a first sleep state and to retain the states of the group of balloon flip-flops but not states of the group of master-slave flip-flops in a deep sleep state.

### BACKGROUND

### Field

Aspects of the present disclosure relate to data retention, and more particularly, to apparatuses and methods for reducing power consumption through retention flip-flop usage.

### Background

Cellular and wireless communication technologies have seen explosive growth over the past several years. This growth has been fueled by better communications hardware, larger networks, and more reliable protocols. Wireless service providers are now able to offer their customers an ever-expanding array of features and services. They provide users with unprecedented levels of access to information, resources, and communications. To keep pace with these service enhancements, wireless devices (e.g., cellular phones, tablets, laptops, etc.) have become faster and more powerful than ever, and now commonly include multiple processors, system-on-chips (SoCs), memories, and other resources (e.g., power rails, etc.) that support high-speed communications and allow device users to execute complex and power intensive software applications on their wireless devices.

To achieve higher density and performance and lower power consumption, CMOS technology has been scaled down for several decades. Supply voltage (VDD) has been scaled down in order to keep the power consumption under control. The transistor threshold voltage (Vth) must be commensurately scaled to maintain a high drive current and achieve performance improvement. However, the threshold voltage scaling results in a substantial increase of the subthreshold leakage current. Therefore, as a result of technology scaling, leakage power is becoming a major contributor to total power consumption. In order to reduce the leakage power consumption, circuits can be put in a power-down mode by switching-off the power supply during a standby mode. However, the state of a circuit which is stored in flip-flops may be lost in the power-down mode. Therefore, retention flip-flops, which stay on partially during power down mode, are required. Adding retention flip-flops increases the design complexity and chip area and contributes toward leakage power. Therefore, it is beneficial to have apparatuses and methods optimizing the use of the retention flip-flops.

### SUMMARY

The following presents a simplified summary of one or more implementations to provide a basic understanding of such implementations. This summary is not an extensive overview of all contemplated implementations, and is intended to neither identify key nor critical elements of all implementations nor delineate the scope of any or all implementations. The sole purpose of the summary is to present concepts relate to one or more implementations in a simplified form as a prelude to a more detailed description that is presented later.

In one aspect, a system comprises a power collapsible logic block, a plurality of retention flip-flops coupled to the power collapsible logic blocks, wherein the plurality of retention flip-flops includes a group of master-slave flip-flops and a group of balloon flip-flops, and a power controller configured to retain states of the group of balloon flip-flops and states of the group of master-slave flip-flops in a first sleep state and to retain the states of the group of balloon flip-flops but not states of the group of master-slave flip-flops in a deep sleep state.

In another aspect, a method for data retention comprises retaining states of a group of balloon flip-flops and states of a group of master-slave flip-flops in a first sleep state; placing the power collapsible logic block in power down; monitoring a sleep time; and entering a deep sleep state and retaining the states of the group of balloon flip-flops but not the states of the group of master-slave flip-flops if the sleep time exceeds a first threshold.

To accomplish the foregoing and related ends, one or more implementations include the features hereinafter fully described and particularly pointed out in the claims. The following description and the annexed drawings set forth in detail certain illustrative aspects of the one or more implementations. These aspects are indicative, however, of but a few of the various ways in which the principles of various implementations may be employed and the described implementations are intended to include all such aspects and their equivalents.

### BRIEF DESCRIPTION OF THE DRAWINGS

FIG. 1 illustrates an example system with data retention according to certain aspects of the present disclosure.

FIG. 2 illustrates an example retention master-slave flip-flop according to certain aspects of the present disclosure.

FIG. 3 illustrates another example system with data retention according to certain aspects of the present disclosure.

FIG. 4 illustrates an example retention balloon flip-flop according to certain aspects of the present disclosure.

FIG. 5 illustrates an exemplary system with data retention according to certain aspects of the present disclosure.

FIG. 6 illustrates another exemplary system with data retention according to certain aspects of the present disclosure.

FIG. 7 illustrates a system state transition according to certain aspects of the present disclosure.

FIG. 8 illustrates an exemplary method for data retention according to certain aspects of the present disclosure.

### DETAILED DESCRIPTION

The detailed description set forth below, in connection with the appended drawings, is intended as a description of various aspects and is not intended to represent the only aspects in which the concepts described herein may be practiced. The detailed description includes specific details for the purpose of providing an understanding of the various concepts. However, it will be apparent to those skilled in the art that these concepts may be practiced without these specific details. In some instances, well-known structures and components are shown in block diagram form in order to avoid obscuring such concepts

Today, wireless devices have become more capable and more powerful. Lower power consumption has been gaining importance in integrated circuit data processing systems due to, for example, wide spread use of portable and handheld applications. Most circuits in handheld devices are typically off (e.g., in an idle or sleep state) for a significant portion of time, consuming only leakage power. As transistor leakage currents increase with finer geometry manufacturing processes, it becomes more difficult to meet chip leakage targets using traditional power reduction techniques. One way to reduce the leakage power is to cut off power to certain blocks of the integrated circuit that are not needed when the device is in a low power sleep mode. However, in doing so, the states of the circuit block are lost. In many circuit blocks state retention through retention flip-flops is needed in order to prevent loss of important information and allow for proper circuit operation and performance when recovering from a low power sleep mode.

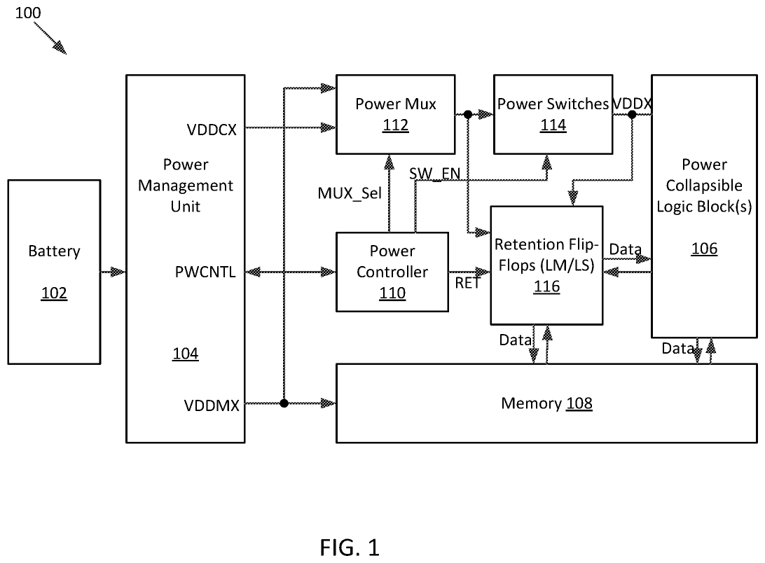

FIG. 1 illustrates an example system with data retention according to certain aspects of the present disclosure. The system 100 is powered by a power management unit 104 coupled to a battery 102. The power management unit 104 provides the necessary supply voltages, such as VDDCX and VDDMX, to other components in the system 100. The system 100 also comprises a plurality of circuit components, such as a power collapsible logic block 106, a memory 108, a plurality of flip-flops, including a plurality of retention flip-flops 116, a power controller 110, a plurality of power mux 112, and a plurality of power switches 114. The power collapsible logic block 106 may be a collection of combination logic circuitry that distributes across the system 100.

The circuit components of the system 100 couple to each other through interconnects. For example, the power management unit 104 provides supply voltages VDDCX and VDDMX as inputs to the power mux 112. The output of power mux 112 couples to the power collapsible logic block 106 and the plurality of retention flip-flops 116. The power controller 110 provides a selection signal, Mux_Sel, to select which supply voltage passed to the output of the power mux 112. The power controller 110 also provides a control signal, SW_EN, to determine when the plurality of power switches 114 is turned on or off, placing the power collapsible logic block 106 in an operation or a non-operation condition. Correspondingly, the power controller 110 also controls the plurality of retention flip-flops 116 whether to retain the states or not depending if the power collapsible logic block 106 is in the non-operation power down or is in the operation condition.

The system 100 may be in an active mode or a sleep mode. In the active mode, the power collapsible logic block 106 and the plurality of retention flip-flops 116 are powered by VDDCX through the plurality of power mux 112 and the plurality of power switches 114. In the sleep mode, the power collapsible logic block 106 is powered down by turning off the plurality of power switches 114. The plurality of retention flip-flops 116, however, is not completely powered off. Each of the plurality of retention flip-flops 116 is a master-slave flip-flop. For each of the plurality of retention flip-flops, a portion, e.g., the master latch or alternatively the slave latch, is powered off with the disabling of the plurality of power switches 114. Another portion, e.g., the corresponding slave latch or alternatively the master latch, is continued to be powered through the power mux 112. There are components in the system 100 that would be always-on (non-collapsible logic), such as the power controller 110 and/or the memory 108. The plurality of power mux 112 is needed to facilitate the switching of power from VDDCX to another power supply VDDMX which may continue to be on, thus enable the circuitry generating VDDCX in the power management unit 104 to be power down, reducing the system power consumption.

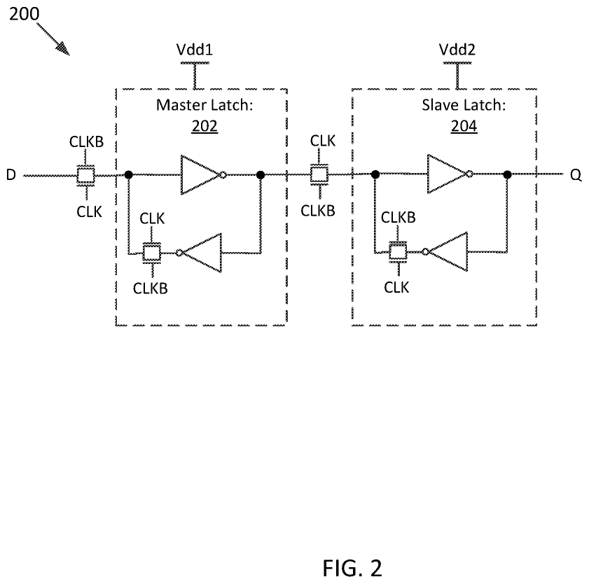

FIG. 2 illustrates an example retention master-slave flip-flop according to certain aspects of the present disclosure. The retention master-slave flip-flop 200 is a conventional D flip-flop, comprising a master latch 202 and a slave latch 204. The retention master-slave flip-flop 200 has a data input D and a clock input CLK and a complementary clock input CLKB and an output Q. It has separate power supply lines for the master latch 202 and the slave latch 204, respectively: Vdd1 for the master latch and Vdd2 for the slave latch. In the active mode, both Vdd1 and Vdd2 couple to the same supply voltage, such as VDDCX in the system 100. During the sleep mode, however, one of the latches is powered down to save the power consumption while the other one is continuously powered to retain the state of the retention master-slave flip-flop 200.

Because the master latch 202 and the slave latch 204 need separate power lines, in the system 100, a plurality of power mux 112 is employed to enable the control of the power supply in both active and sleep modes. Power mux, however, takes up significant chip area and itself contributes toward leakage power.

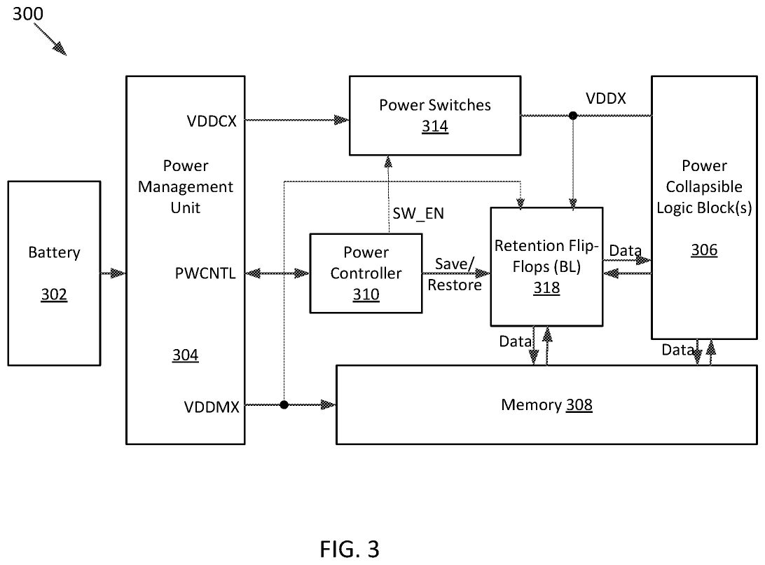

FIG. 3 illustrates another example system with data retention according to certain aspects of the present disclosure. Like the system 100, the system 300 is powered by a power management unit 304 coupled to a battery 302. The power management unit 304 provides the necessary supply voltages, such as VDDCX and VDDMX, to other components in the system 300. The system 300 also comprises a plurality of circuit components, such as a power collapsible logic block 306, a memory 308, a plurality of flip-flops, including a plurality of retention flip-flops 318, a power controller 310, and a plurality of power switches 314.

The circuit components of the system 300 couple to each other through interconnects. For example, the power management unit 304 provides supply voltages VDDCX to the plurality of power switches 314. The power controller 310 provides a control signal, SW_EN, to determine when the plurality of power switches 314 is turned on or off, placing the power collapsible logic block 306 in an operation or a non-operation condition. Correspondingly, the power controller 110 also controls the plurality of retention flip-flops 318 whether to retain the states or not depending if the power collapsible logic block 306 is in the non-operation power down or is in the operation condition.

The system 300 may be in an active mode or a sleep mode. In the active mode, the power collapsible logic block 306 and the plurality of retention flip-flops 318 are powered by VDDCX through the plurality of power switches 314. In the sleep mode, the power collapsible logic block 306 is powered down by turning off the plurality of power switches 314. The plurality of retention flip-flops 318, however, is not completely powered off. Each of the plurality of retention flip-flops 318 is a balloon flip-flop. A balloon flip-flop has a third, retention latch, in addition to the master and slave latches. For each of the plurality of retention flip-flops 318, a portion, e.g., the master and slave latches, are powered off with the disabling of the plurality of power switches 314. Another portion, e.g., the retention latch, is continued to be powered through the supply voltage VDDMX. There are components in the system 300 that would be always-on (non-collapsible logic), such as the power controller 310 and/or the memory 308.

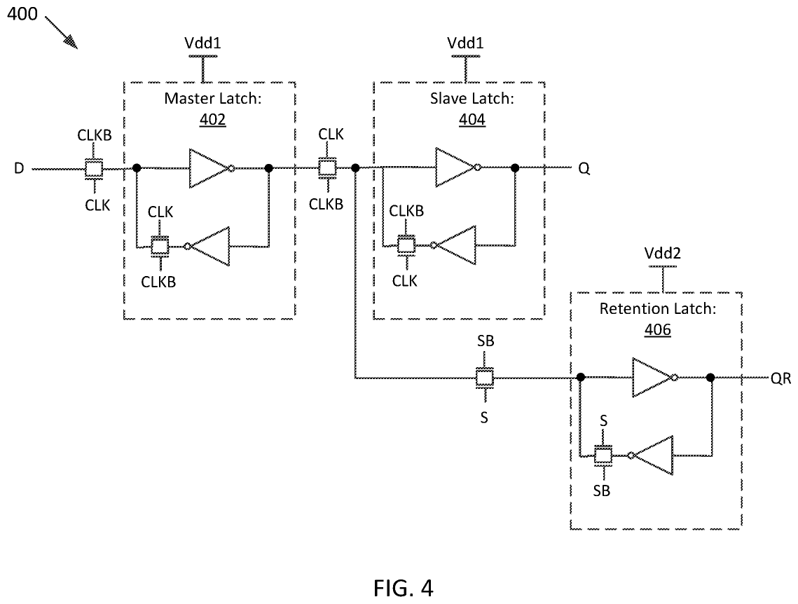

FIG. 4 illustrates an example retention balloon flip-flop according to certain aspects of the present disclosure. The balloon flip-flop 400 comprises three latches: a master latch 402, a slave latch 404, and a retention latch 406. The balloon flip-flop 400 has a data input D, a clock input CLK and a complementary clock input CLKB, and a retention select signal S and its complementary SB. The balloon flip-flop 400 also has an output Q and retention output QR. It has separate power supply lines for the master latch 402, the slave latch 404, and the retention latch 406: Vdd1 for both the master latch 402 and the slave latch 404, but Vdd2 for the retention latch 406. In the active mode, Vdd1 is powered on, such as by VDDCX in the system 300. Vdd2, however, may be powered on or off. If Vdd2 is powered on, it could be VDDCX or VDDMX in the system 300. However, it's decoupled from the master latch 402 and slave latch 404 through the retention select signal S and its complementary SB to reduce the toggling and save the active power. During the sleep mode, the master latch 402 and the slave latch 404 are powered down to save the power consumption while the retention latch 406 is powered on to retain the state of the retention balloon flip-flop 400. When the system is back to active mode from the sleep mode, the data retained by the retention latch 406 may be restored to the master latch 402 and the slave latch 404.

The use of the retention balloon flip-flops as the retention flip-flops eliminates the need of power mux. However, a balloon flip-flop requires larger area, e.g., 2 to 4 time larger, and consumes higher leakage, e.g., 2 time higher, than a typical master-slave flip-flop.

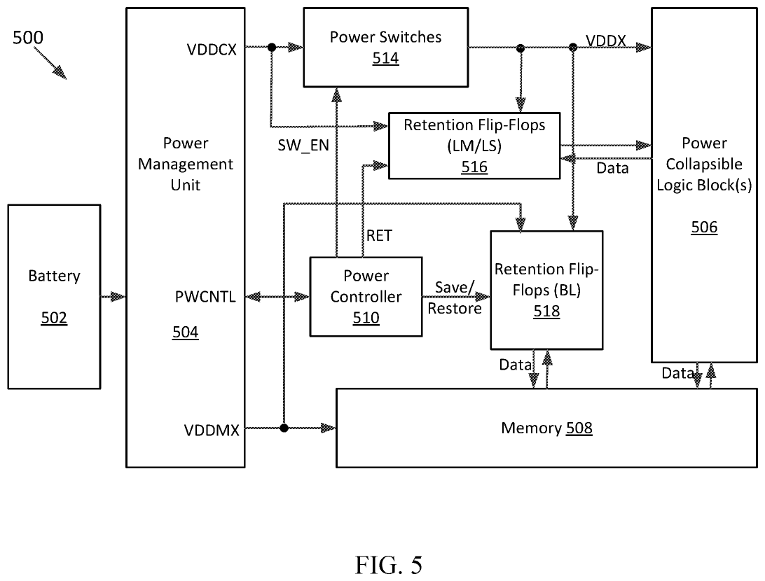

FIG. 5 illustrates an exemplary system with data retention according to certain aspects of the present disclosure. Similar to the systems 100 and 300, the system 500 is powered by a power management unit 504 coupled to a battery 502. The power management unit 504 provides the necessary supply voltages, such as VDDCX and VDDMX, to other components in the system 500. The system 500 also comprises a plurality of circuit components, such as a power collapsible logic block 506, a memory 508, a plurality of retention flip-flops, including a group of master-slave flip-flops 516 and a group of balloon flip-flops 518, a power controller 510, and a plurality of power switches 514.

The circuit components of the system 500 couple to each other through interconnects. For example, the power management unit 504 provides supply voltages VDDCX to the plurality of power switches 514. The power controller 510 provides a control signal, SW_EN, to determine when the plurality of power switches 514 is turned on or off, placing the power collapsible logic block 506 in an operation or a non-operation condition. Correspondingly, the power controller 510 also controls the plurality of retention flip-flops whether to retain the states or not depending if the power collapsible logic block 306 is in the non-operation power down or is in the operation condition.

The system 500 may be in an active mode or a sleep mode. In the active mode, the power collapsible logic block 506 and the plurality of retention flip-flops, including every portion of the group of master-slave flip-flops 516 (e.g., both the master latch and the slave latch of each master-slave flip-flops) and a portion of each of the group of balloon flip-flops 518 (e.g., the master and slave latches) are powered on by VDDCX through the plurality of power switches 514. In addition, the retention latch of each of the group of balloon flip-flops 518 may be powered on (but decoupled from the master and slave latches) by another power supply, such as VDDMX or is powered off.

In the sleep mode, the power collapsible logic block 506 is powered down by turning off the plurality of power switches 514. However, not all states of the plurality of retention flip-flops are retained. It depends on how long the system stays in the sleep mode. Retained states are the states of the system at the moment of sleep. When the system wakes up and goes to the active mode at a later time, the context and environment of system have changed. The value of information retained decreases. A fraction of retained states may become irrelevant or less relevant. Therefore, it would be beneficial to selectively retain states based on the time that system stays in the sleep mode to achieve both power and area saving.

Depending on the relevancy of states for a system from a sleep mode to an active mode, different types of retention flip-flops are used. A state that is only useful if the system returns to the active mode shortly after entering sleep mode may be assigned to a master-slave flip-flop as a retention flip-flop. If a system stays in the sleep mode longer than a predetermined time, e.g., a first threshold, less relevant states will not be retained. Those states that are still relevant after the system goes to the active mode are retained in balloon flip-flops to save power consumption at the expense of more chip area.

The power controller 510 is configured to retain states of the group of master-slave flip-flops 516 and the group of balloon flip-flops 518 at the beginning of the system 500 entering a sleep mode. This is known as a first sleep state. The power controller 510 is configured to monitor the sleep time. If the sleep time exceeds a threshold (e.g., a predetermined time), indicating some states may become irrelevant or less relevant when the system 500 is back to the active mode. This is known as a deep sleep state. The power controller 510 may then put the group of master-slave flip-flops 516 into low power mode, such as placing the group of master-slave flip-flops 516 in power down. The states of the group of master-slave flip-flops 516 thus are no longer retained. The states of the group of the balloon flip-flops 518, however, are still maintained by the retention latches.

In the deep sleep state, since the group of master-slave flip-flops 516 is powered down, all circuit components powered by VDDCX are off. The power management unit 504 may turn off VDDCX, saving power consumption. This can be done through power controller 510 sending a signal to the power management unit 504.

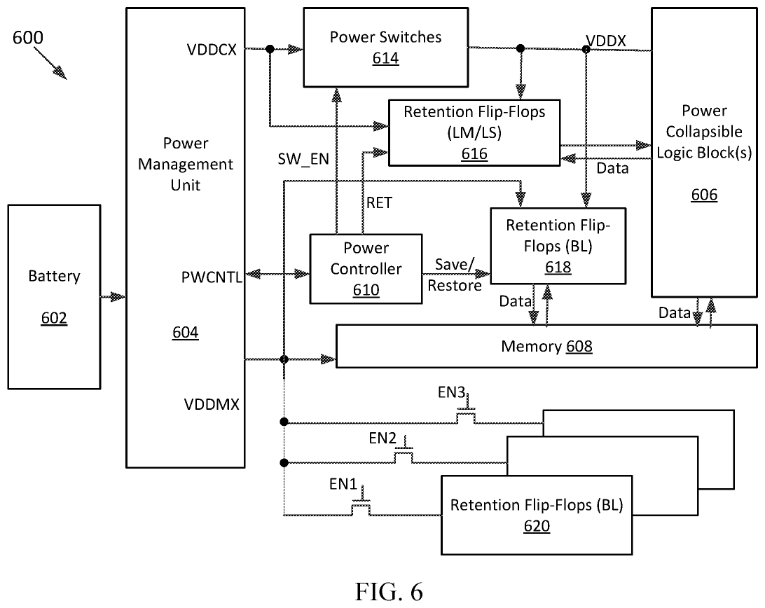

FIG. 6 illustrates another exemplary system with data retention according to certain aspects of the present disclosure. The system 600 is similar to the system 500 that is powered by a power management unit 604 coupled to a battery 602. The power management unit 604 provides the necessary supply voltages, such as VDDCX and VDDMX, to other components in the system 600. The system 600 also comprises a plurality of circuit components, such as a power collapsible logic block 606, a memory 608, a plurality of retention flip-flops, including a group of master-slave flip-flops 616 and a group of balloon flip-flops 618, a power controller 610, and a plurality of power switches 614. The operation of the circuit components in the system 600 is also similar to those in the system 500.

The system 600, however, also comprises one or more second groups of retention flip-flops 620. The one or more second groups of retention flip-flops 620 may be master-slave flip-flops (e.g., the master-slave flip-flops 200) or balloon flip-flops (e.g., the balloon flip-flops 400) but preferably balloon-flip-flops. The power to each group of balloon flip-flops 620 is gated by an enable signal EN1, EN2, EN3, . . . . The enable signals EN1, EN2, EN3, . . . come from the power controller 610. With the addition of the one or more second group of retention flip-flops 620, more sleep states may be supported. For example, at the beginning of the sleep, i.e., the first sleep state, the states of all retention flip-flops are retained, including the group of master-slave flip-flops 616, the group of balloon flip-flops 618, and the one or more second groups of retention flip-flops 620. Similar to the system 500, when the sleep time exceeds a first threshold, the group of master-slave flip-flops 616 are placed into sleep and no states of the group of master-slave flip-flops 616 are retained. In addition, the one or more second groups of retention flip-flops 620 are also placed into sleep and no states of the one or more second groups of retention flip-flops 620 are retained. Only the states of the group of balloon flip-flops 618 are retained. The system 600 thus enters a deep sleep state. However, between the first sleep state and the deep sleep state, there may be other sleep states, e.g., a second sleep state. If the sleep time exceeds a second threshold, wherein the second threshold is smaller than the first threshold, one of the one or more second group of retention flip-flops 620 is powered down and the corresponding states are no longer retained. The system 600 is therefore in the second sleep state. The process continues until finally only states in the group of balloon flip-flops 618 are retained and the system is in the deep sleep state.

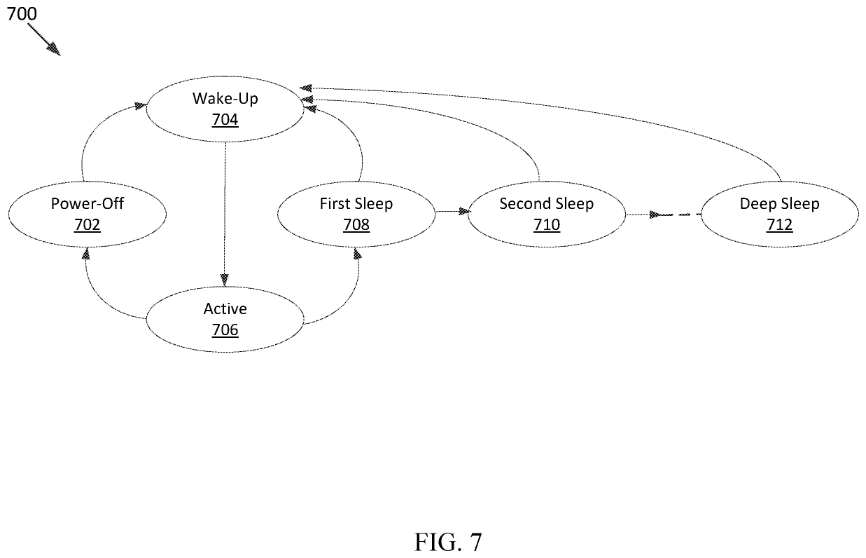

FIG. 7 illustrates a system state transition according to certain aspects of the present disclosure. The state diagram 700 comprises a power-off state 702, a wake-up state 704, an active state 706, and several sleep states 708, 710, 712. The system may comprise other suitable states. At the power-off state 702, the system has yet to be started. After the system starts, it moves to the wake-up state 704 where the system may be initialized and/or boot up. Thereafter, the system moves to the active state 706. From the active state 706, the system may be turned off and goes back to the power-off state 702. Alternatively, the system may be placed into a low power idle mode, waiting for next tasks. In the low power idle mode, the system may be in one of the several sleep states 708, 710, 712. The system first enters the first sleep state 708. In the first sleep state 708m the states of all retention flip-flops are retained. For example, for the system 500, the states of the group of master-slave flip-flops 516 and the states of the group of balloon flip-flops 518 are all retained. For the system 600, the states of the one or more second groups of retention flip-flops 620 are also retained in addition to the states of the group of master-slave flip-flops 616 and the states of the group of balloon flip-flops 618.

If the system stays in the first sleep state longer than a first threshold, then the system moves to the deep sleep state, where fewer states of the flip-flops are retained. For example, in both the system 500 and the system 600, the states of the group of master-slave flip-flops 516 are no longer retained. In addition, in the system 600, the states of the one or more second group of retention flip-flops 620 are no longer retained. For the system 600, however, if the system's sleep time is longer than a second threshold, where the second threshold is smaller than the first threshold, the system may first go to a second sleep state, or a third sleep state, and so on, until finally to the deep sleep state 712. Over the process, fewer and fewer states are retained. For example, more and more states of the one or more second groups of retention flip-flops 620 are not retained.

The system may wake up from each of the sleep states 708, 710, 712 and goes to the wake-up state 704. At the wake-up state 704, if the states of the flip-flops are retained during sleep, the states would be restored back to the flip-flops and thereafter the system goes back to the active state 706.

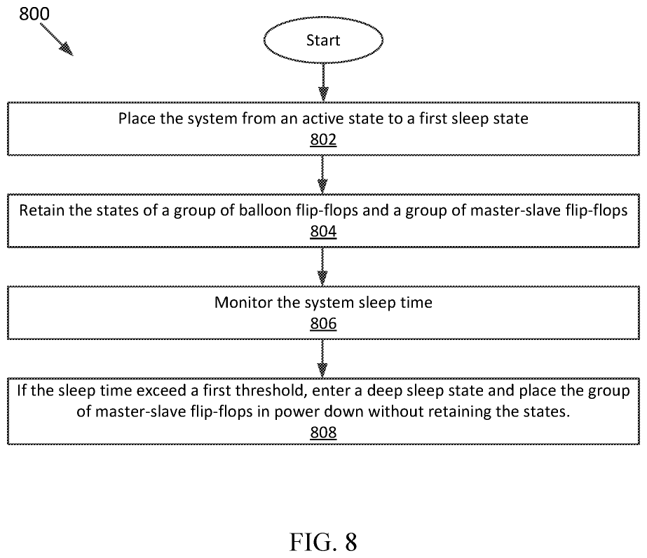

FIG. 8 illustrates an exemplary method for data retention according to certain aspects of the present disclosure. The method 800 starts when a system is ready to enter a low power idle mode. At 802, the system is placed from an active state (e.g., the active state 706) to a first sleep state (e.g., the first sleep state 708) by removing the power to power collapsible circuitry (e.g., the power collapsible logic 506 or the power collapsible logic block 606). Meanwhile at 804, the states of the group of balloon flip-flops and the group of master-slave flip-flops are retained. As a result, A portion (e.g., both the master latch 402 or the slave latch 404) of each of a group of balloon flip-flops (e.g., the group of balloon flip-flops 518 or the group of balloon flip-flops 618) and a portion (e.g., either the master 202 or the slave latches 204) of a group of master-slave flip-flops (e.g., the group of master-slave flip-flops 516 or the group of master-slave flip-flops 616) are power down to save the power consumption. Another portion (e.g., the retention latch 406) of each group of balloon flip-flops and another portion (e.g., either the corresponding slave latch 204 or the master latch 202) of a group of master-slave flip-flops are powered to retain the states.

At 806, the sleep time of the system is monitored. If the sleep time exceeds a first threshold, then the system enters a deep sleep state (e.g., the deep sleep state 712) at 808. As a result, the group of master-slave flip-flops is completely powered off. The states of the master-slave flip-flops are no longer retained, further reducing the power consumption. The states of the group of balloon flip-flops are continually retained with the continuous power of the retention latches. In addition, a signal may be sent for a power management unit (e.g., the power management unit 503 or the power management unit 604) to shut off the supply voltage to the group of the master-slave flip-flops.

Optionally, there may be intermediate one or more sleep states (e.g., the second sleep state 710) between the first sleep state and the deep sleep state with one or more second groups of retention flip-flops (e.g., the one or more second groups of retention flip-flops 620). If the system further comprises one or more second groups of retention flip-flops, at 804, the states of the one or more second groups of retention flip-flops are retained, too. The system may enter a second sleep state after detecting that the sleep time exceed a second threshold, which is smaller than the first threshold. At the second sleep state, the states of the group of master-slave flip-flops are no longer retained, further reducing the power consumption. The states of the group of balloon flip-flops and the states of the one or more groups of retention flip-flops are continually retained with the continuous power of the retention latches. The system sleep time is continuously monitored. If the sleep time exceeds a third threshold, the system enters a third sleep state. The one or more second groups of retention flip-flops are powered down and the corresponding states are no longer retained. The process continues until the system enters deep sleep state where only the states of the group of balloon flip-flops are retained.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples described herein but is to be accorded the widest scope consistent with the principles and novel features disclosed herein.

What is claimed is:

1. A system, comprising:
a power collapsible logic block;
a plurality of retention flip-flops coupled to the power collapsible logic block, wherein the plurality of retention flip-flops includes a group of master-slave flip-flops and a group of balloon flip-flops; and
a power controller configured to retain states of the group of balloon flip-flops and states of the group of master-slave flip-flops in a first sleep state and to retain the states of the group of balloon flip-flops but not states of the group of master-slave flip-flops in a deep sleep state.

2. The system of claim 1, wherein the power controller is further configured to place the system in the deep sleep state when a sleep time of the system exceeds a first threshold.

3. The system of claim 2, wherein the power controller is further configured to send a signal to a power management unit to turn off a supply voltage when the sleep time of the system exceeds the first threshold.

4. The system of claim 1, wherein the system is configured to be in the first sleep state before in the deep sleep state.

5. The system of claim 1, wherein the power collapsible logic block is configured to be powered down both in the first sleep state and in the deep sleep state.

6. The system of claim 5, wherein only a portion of each of the group of master-slave flip-flops is configured to be powered down in the first sleep state and each of the group of master-slave flip-flops is configured to be powered down in the deep sleep state.

7. The system of claim 5, wherein a first portion of each of the group of balloon flip-flops is configured to be powered down both in the first sleep state and in the deep sleep state.

8. The system of claim 5, wherein the power collapsible logic block is configured to stay in power down longer when it enters the deep sleep state than the first sleep state.

9. The system of claim 1, wherein the power collapsible logic block is further configured to be in operation in an active state.

10. The system of claim 9, wherein every portion of each of the group of master-slave flip-flops and a first portion of each of the group of balloon flip-flops are configured to be in operation in the active state, and a second portion of each of the group of balloon flip-flops is configured to be in non-operation in the active state.

11. The system of claim 1, wherein the plurality of retention flip-flops further includes a second group of retention flip-flops configured to retain states in the first sleep state but not in the deep sleep state, and wherein the power controller is further configured to retain the states of the group of balloon flip-flops and the states of the second group of retention flip-flops but not the states of the group of master-slave flip-flops in a second sleep state.

12. The system of claim 11, wherein the second group of retention flip-flops comprises balloon flip-flops.

13. The system of claim 11, wherein the power controller is configured to place the system in the deep sleep state when a sleep time of the system exceeds a first threshold and in the second sleep state when the sleep time exceeds a second threshold.

14. The system of claim 13, wherein the first threshold is larger than the second threshold.

15. The system of claim 13, wherein the system is configured to enter the first sleep state before it enters the second sleep state and wherein the system is further configured to enter the second sleep state before it enters the deep sleep state.

16. The system of claim 1 further comprising a non-collapsible logic coupled to a supply voltage and configured to be in operation in both the first sleep state and the deep sleep state.

17. A method for data retention, comprising:
retaining states of a group of balloon flip-flops and states of a group of master-slave flip-flops in a first sleep state;
placing a power collapsible logic block in power down;
monitoring a sleep time; and
entering a deep sleep state and retaining the states of the group of balloon flip-flops but not the states of the group of master-slave flip-flops if the sleep time exceeds a first threshold.

18. The method of claim 17 further comprising sending a signal to a power management unit to turn off a supply voltage when the sleep time exceeds the first threshold.

19. The method of claim 17, wherein a portion of each of the group of master-slave flip-flops is configured to be powered down in the first sleep state and each of the group of master-slave flip-flops is configured to be powered down in the deep sleep state.

20. The method of claim 17, wherein a first portion of each of the group of balloon flip-flops is configured to be powered down in both the first sleep state and the deep sleep state.

21. The method of claim 20, wherein a second portion of each of the group of balloon flip-flops is configured to be powered on both in the first sleep state and in the deep sleep state.

22. The method of claim 21, wherein the first portion of each of the group of balloon flip-flops is configured to be in operation in an active state and the second portion of each of the group of balloon flip-flops is configured to be in non-operation in the active state.

23. The method of claim 17 further comprising:
placing the power collapsible logic block in power up in an active state; and
restoring the states of the group of balloon flip-flops in the active state.

24. The method of claim 17 further comprising:
retaining states of a second group of retention flip-flops in the first sleep state but not the deep sleep state;
entering a second sleep state if the sleep time exceeds a second threshold; and
retaining states of the second group of retention flip-flops and the group of balloon flip-flops but not the group of master-slave flip-flops in the second sleep state.

25. The method of claim 24 wherein the second threshold is smaller than the first threshold.
